(19) United States
(12) Patent Application Publication
(10) Pub. No.: US 2024/0354125 A1
(43) Pub. Date: Oct. 24, 2024

(54) METHOD FOR DISPLAYING MEDIA RESOURCE, DEVICE AND STORAGE MEDIUM

(71) Applicant: BEIJING DAJIA INTERNET INFORMATION TECHNOLOGY CO., LTD., Beijing (CN)

(72) Inventor: Zihui YE, Beijing (CN)

(21) Appl. No.: 18/240,696

(22) Filed: Aug. 31, 2023

(30) Foreign Application Priority Data
Apr. 20, 2023 (CN) 202310430333.7

(51) Int. Cl. G06F 9/451; G06F 16/45; G06Q 50/00

(52) U.S. Cl. CPC G06F 9/451; G06F 16/45; G06Q 50/01

(57) ABSTRACT

A method for displaying a media resource includes: displaying a first interaction page corresponding to the first user account. The first interaction page is configured to display interaction information between the first user account and a second user account, the first user account and the second user account are in a target social relation, the interaction information includes a historical interaction media resource. The first interaction page includes an interaction media resource entry, and a second interaction page is displayed in response to a triggering operation on the interaction media resource entry, and the second interaction page is configured to display the historical interaction media resource. The historical interaction media resource includes one or more media resources generated based on one or more historical interaction operations between the first user account and the second user account.

### CROSS-REFERENCE TO RELATED APPLICATION

This application claims the priority to Chinese Patent Application No. 202310430333.7, filed on Apr. 20, 2023, the entire contents of which are incorporated herein by reference in their entireties.

### TECHNICAL FIELD

The disclosure relates to the field of Internet technology, in particular to a method for displaying a media resource, a device, and a storage medium.

### BACKGROUND

With the development of technology, social software has more and more interaction functions. In particular, in the social software, in the case of establishing some kind of social relations (e.g., an intimate relation or a friend relation) between users, the users cannot obtain more interaction experience from the established social relations, which makes it difficult for the users to experience the fun of interaction.

Therefore, how to improve the fun of interaction function is a technical problem that needs to be solved currently.

### SUMMARY

According to a first aspect of the disclosure, a method for displaying a media resource, performed by a terminal device of a first user account, is provided. The method includes: displaying a first interaction page corresponding to the first user account, in which the first interaction page is configured to display interaction information between the first user account and a second user account, the first user account and the second user account are in a target social relation, the interaction information includes a historical interaction media resource; and displaying a second interaction page in response to a triggering operation on an interaction media resource entry, in which the first interaction page includes the interaction media resource entry, and the second interaction page is configured to display the historical interaction media resource. The historical interaction media resource includes one or more media resource generated based on one or more historical interaction operations between the first user account and the second user account.

According to a second aspect of the disclosure, a terminal device including a processor and a communication interface coupled to the processor is provided. The processor is configured to execute computer programs or instructions to implement the method for displaying a media resource according to the first aspect.

According to a third aspect of the disclosure, a computer-readable storage medium having instructions stored thereon is provided. When the instructions are executed by a computer, the method for displaying a media resource according to the first aspect is implemented by the computer.

It is understandable that the above general description and the following detailed descriptions are illustrative and explanatory only and are not used to limit the disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure, and do not constitute an undue limitation of the disclosure.

FIG. 1 is a schematic diagram of a media resource interaction system according to an embodiment of the disclosure.

FIG. 2 is a first flowchart of a method for displaying a media resource according to an embodiment of the disclosure.

FIG. 3 is a first schematic diagram of a method for displaying a media resource according to an embodiment of the disclosure.

FIG. 4 is a second flowchart of the method for displaying a media resource according to an embodiment of the disclosure.

FIG. 5 is a third flowchart of the method for displaying a media resource according to an embodiment of the disclosure.

FIG. 6 is a fourth flowchart of the method for displaying a media resource according to an embodiment of the disclosure.

FIG. 7 is a fifth flowchart of the method for displaying a media resource according to an embodiment of the disclosure.

FIG. 8 is a sixth flowchart of the method for displaying a media resource according to an embodiment of the disclosure.

FIG. 9 is a second schematic diagram of the method for displaying a media resource according to an embodiment of the disclosure.

FIG. 10 is a third schematic diagram of the method for displaying a media resource according to an embodiment of the disclosure.

FIG. 11 is a block diagram of an apparatus for displaying a media resource according to an embodiment of the disclosure.

FIG. 12 is a schematic diagram of a terminal device according to an embodiment of the disclosure.

### DETAILED DESCRIPTION

In order to enable those skilled in the art to better understand the technical solutions of the disclosure, the technical solutions in the embodiments of the disclosure will be clearly and completely described below with reference to the accompanying drawings.

It should be noted that the terms “first”, “second”, etc. in the specification and claims of the disclosure and the above accompanying drawings are used to distinguish similar objects and do not indicate a particular order or sequence. It should be understood that the terms used in this way can be interchanged in appropriate cases, so that the embodiments of the disclosure described herein can be implemented in an order other than those illustrated or described herein. The embodiments described in the following exemplary embodiments do not represent all embodiments consistent with the disclosure. Instead, they are only examples of devices and methods consistent with some aspects of the disclosure as described in detail in the appended claims.

Before providing a detailed description of a method for displaying a media resource provided by the disclosure, relevant elements, application scenarios, and implementation environments involved in this disclosure are briefly described at first.

Firstly, the application scenarios involved in this disclosure are briefly described.

With the development of technology, social software has more and more interaction functions. In particular, in the social software, in the case of establishing certain social relations (e.g., an intimate relation or a friend relation) between users, the users cannot obtain more interaction experience from the established social relations, which makes it difficult for the users to experience the fun of interaction.

For example, at social platform 1, after user A and user B have established a couple relation, user A and user B cannot use the couple relation to interact with each other at the social platform 1, and thus user A and user B are unclear about the substantial meaning of establishing the couple relation.

Therefore, how to improve the fun of interaction function is a technical problem that needs to be solved urgently at present.

With respect to the above problem, the disclosure provides a method for displaying a media resource, performed by a terminal device of a first user account. The method includes: displaying a first interaction page corresponding to the first user account by the terminal device. The first interaction page is configured to display interaction information between the first user account and a second user account, the first user account and the second user account are in a target social relation, the interaction information includes a historical interaction media resource. The terminal device displays the historical interaction media resource in a second interaction page in response to a triggering operation on an interaction media resource entry in the first interaction page. The historical interaction media resource includes one or more media resources generated based on one or more historical interaction operations between the first user account and the second user account.

In this way, after the target social relation between the first user account and the second user account is established, the terminal device can display the historical interaction media resource between the first user account and the second user account, which makes it convenient for the users who are in the target social relation to view the interaction media resources, and enhances the fun of the interaction function. In addition, by displaying the historical interaction media resource, the motivation for interaction between the users who are in the target social relation is improved and the user viscosity is enhanced.

Finally, an implementation environment (implementation architecture) involved in the method provided by the disclosure is briefly described.

The method for displaying a media resource according to the embodiments of the disclosure may be applicable to a media resource interaction system. FIG. 1 illustrates a schematic diagram of the media resource interaction system. As illustrated in FIG. 1, the media resource interaction system 10 includes terminal device 1 and terminal device 2. Terminal device 1 is a terminal device of a first user account, and terminal device 2 is a terminal device of a second user account.

In the media resource interaction system, the first user account posts an interaction media resource through terminal device 1, and both terminal device 1 and terminal device 2 are able to obtain the interaction media resource. The interaction media resource is displayed on a second interaction page displayed by terminal device 1, and the interaction media resource is also displayed on a second interaction page displayed by terminal device 2. Correspondingly, the second user account posts an interaction media resource through terminal device 2, both terminal device 1 and terminal device 2 are able to obtain the interaction media resource. The interaction media resource is displayed on the second interaction page displayed by terminal device 1, and the interaction media resource is also displayed on the second interaction page displayed by terminal device 2.

For example, the first user account posts 3 photos and @, the second user account via terminal device 1, both terminal device 1 and terminal device 2 can obtain the 3 photos and display the 3 photos on the second interaction page of the corresponding terminal device. Correspondingly, the second user account posts a photo and @ the first user account via terminal device 1, both terminal device 1 and terminal device 2 obtain the photo and display it on the second interaction page of the corresponding terminal device.

A target terminal device is configured to display a first interaction page corresponding to a target user account. The first interaction page is configured to display interaction information between a first user account and a second user account, the first user account and the second user account are in a target social relation, and the interaction information includes a historical interaction media resource. The target terminal device is terminal device 1 or terminal device 2, and the target user account is the first user account or the second user account. The first interaction page further includes an interaction media resource entry. The target terminal device is further configured to display a second interaction page in response to a triggering operation on the interaction media resource entry, and the second interaction page is configured to display historical interaction media resources. The historical interaction media resources are media resources generated based on historical interaction operations between the first user account and the second user account.

The target terminal device is further configured to, in response to detecting a currently posted interaction media resource on a third interaction page, obtain the current interaction media resource and display the current interaction media resource on the second interaction page.

The target terminal device includes a camera. An apparatus for displaying a media resource is further configured to acquire an image via the camera and output the image for display.

In some embodiments, the media resources may include images, videos and texts, and the form of the media resources is not limited in the embodiments of the disclosure.

In some embodiments, the target terminal device is installed with a target application. The first user account and the second user account are user accounts of the target application, and the target social relation is established between the first user account and the second user account on the target application.

The target terminal device can be, but is not limited to, a cell phone, a tablet computer, a laptop, a personal computer, and other devices that support running of application clients.

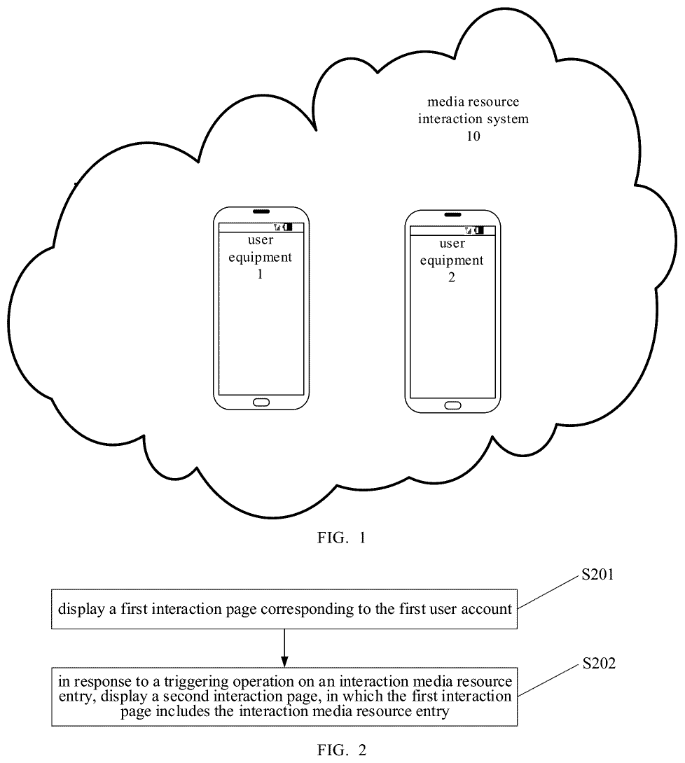

FIG. 2 is a first flowchart of a method for displaying a media resource according to an embodiment of the disclosure. In some embodiments, the above method for displaying a media resource may be performed by the terminal device 1 or terminal device 2 as shown in FIG. 1, and may also be performed by other similar devices. The following embodiments of the disclosure are described by taking terminal device 1 as an example.

In order to improve the fun of interaction function, the embodiment of the disclosure provides a method for displaying a media resource, performed by a terminal device of a first user account. As shown in FIG. 2, the method includes S201 to S202.

At step S201, the terminal device displays a first interaction page corresponding to the first user account.

The first interaction page is configured to display interaction information between the first user account and a second user account, the first user account and the second user account are in a target social relation, and the interaction information includes a historical interaction media resource.

In a possible implementation, the terminal device runs a target application after opening the target application and displays a target social relation entry. The terminal device displays the first interaction page corresponding to the first user account in response to a triggering operation on the target social relation entry.

In some embodiments, the first interaction page is also configured to display information about the first user account and the second user account.

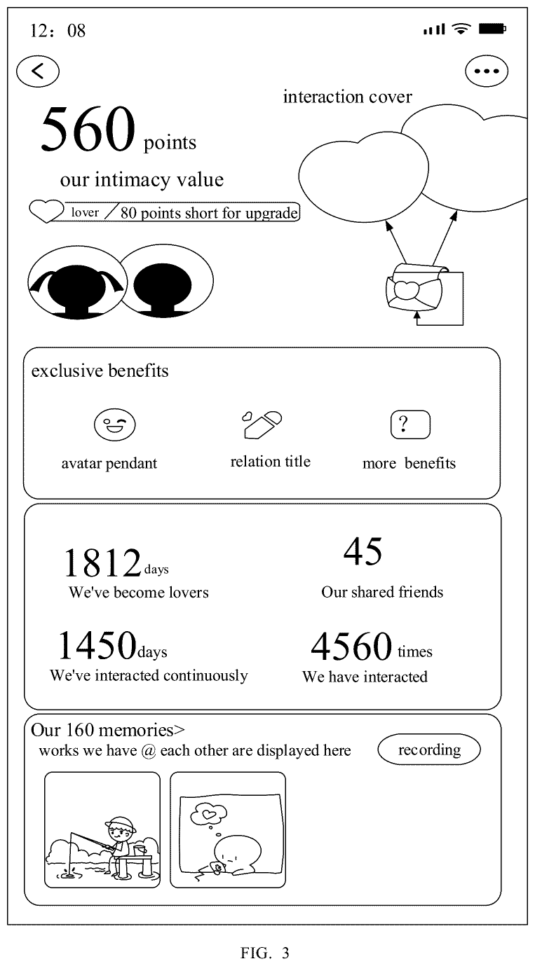

For example, FIG. 3 is used as an example. In FIG. 3, the first interaction page includes information about the first user account and the second user account, such as an avatar of the first user account, an avatar of the second user account, a duration of existence of the target social relation between the first user account and the second user account: e.g., 1812 days, and a number of shared friends between the first user account and the second user account: 45. The first interaction page further includes the interaction information between the first user account and the second user account: a social value of the first user account and the second user account: 560 points, a social level corresponding to the social value: 3, a social relationship: lovers, a social difference from the next social level: 80 points, an interaction cover for the target social relation, a number of consecutive days of interaction: 1450 days, a number of interactions: 4560 times, and historical interaction media resources.

For example, in FIG. 3, an entry “we have 160 memories” is shown and a plurality of associated historical interaction media resources are shown.

In some embodiments, the terminal device obtains a number of days of interaction, a number of interactions, and the duration of existence of the target social relation between the first user account and the second user account, and inputs the number of days of interaction, the number of interactions, and the duration of existence of the target social relation into a first preset social value algorithm to obtain a social value.

In another embodiment, the terminal device obtains the number of days of interaction and the number of interactions between the first user account and the second user account, the number of shared friends between the first user account and the second user account, and the duration of existence of the target social relation, and inputs the number of days of interaction, the number of interactions, the number of shared friends between the first user account and the second user account, and the duration of existence of the target social relation into a second preset social value algorithm to obtain a social value.

It should be noted that the first preset social value algorithm and the second preset social value algorithm are preconfigured in the terminal device by the operation and maintenance personnel, and the mode of calculating the social value is not limited in the embodiments of disclosure.

In some embodiments, the interaction cover may be set by the first user account or may be determined based on the social value.

For example, after obtaining the social value, the terminal device determines a target interaction cover identifier corresponding to the social value based on a preset cover mapping relation, and determines the target interaction cover based on the target interaction cover identifier. The preset cover mapping relation includes a plurality of social values and interaction cover identifiers corresponding to the social values respectively. The terminal device displays the target interaction cover.

In some embodiments, the first interaction page further includes a shooting control and exclusive benefits, such as an avatar pendant and a relation title.

For example, in FIG. 3, a “recording” shooting control is shown.

At step S202, the first interaction page includes an interaction media resource entry, the terminal device displays a second interaction page in response to a triggering operation on the interaction media resource entry.

The second interaction page is configured to display the historical interaction media resource. The historical interaction media resource includes one or more media resource generated based on one or more historical interaction operations between the first user account and the second user account.

As a possible implementation, the first interaction page further includes an interaction media resource entry. Upon detecting the triggering operation on the interaction media resource entry, the terminal device displays the second interaction page in response to the triggering operation on the interaction media resource entry.

In some embodiments, after displaying the first interaction page, the terminal device detects a click operation on the interaction media resource entry, the terminal device displays the second interaction page in response to the click operation on the interaction media resource entry.

In some embodiments, after displaying the first interaction page, the terminal device detects a long press operation on the interaction media resource entry, the terminal device displays the second interaction page in response to the long press operation on the interaction media resource entry.

In some embodiments, the interaction media resource entry may be an entry area on the first interaction page.

For example, the triggering operation is a click operation. The terminal device displays the second interaction page in response to a click operation on the entry area.

In some embodiments, the interaction media resource entry may be an entry control on the first interaction page.

For example, as illustrated in FIG. 3, an entry control of the interaction media resource entry “we have 160 memories” is shown in FIG. 3, and the trigger operation is a click operation. The terminal device displays the second interaction page in response to the click operation on the entry control.

It should be noted that the triggering operation is not limited in the embodiments of the disclosure.

In some embodiments, in response to a triggering operation on the interaction media resource entry, the terminal device obtains a post time point of each of a plurality of historical interaction media resources and displays the plurality of historical interaction media resources on the second interaction page in a reverse chronological order of the post time points of the plurality of historical interaction media resources. Further, the terminal device classifies the plurality of historical interaction media resources according to a preset time range on the second interaction page.

In some embodiments, the terminal device obtains a historical year when the historical interaction media resource is posted, and displays the historical year at a corresponding location of the historical interaction media resource.

The specific implementation of this step can be referred to subsequent steps and will not be repeated herein.

The disclosure provides a method for displaying a media resource, which brings about the following beneficial effects. The terminal device displays the first interaction page corresponding to the first user account when the first user account establishes the target social relation (e.g., an intimate relation or a friend relation) with the second user account, in which the first interaction page is configured to display the interaction information between the first user account and the second user account. Further, the terminal device displays the second interaction page in response to the triggering operation on the interaction media resource entry, in which the second interaction page is configured to display the historical interaction media resource, and the historical interaction media resource comprises one or more media resources generated based on one or more historical interaction operations between the first user account and the second user account.

In this way, after establishing the target social relation between the first user account and the second user account, the terminal device can display the historical interaction media resource between the first user account and the second user account, which makes it convenient for the users who are in the target social relation to view the interaction media resource, and enhances the fun of interaction function. In addition, by displaying the historical interaction media resource, the motivation for interaction between the users who are in the target social relation is enhanced and the user viscosity is improved.

In a design, in order to increase the fun of interaction function, S202 provided in the embodiment of the disclosure further includes S2021.

At step S2021, the terminal device displays a first type historical interaction media resource and a second type historical interaction media resource on the second interaction page.

The first type historical interaction media resource is posted by the second user account, and the second type historical interaction media resource is posted by the first user account. A display priority of the first type historical interaction media resource is higher than that of the second type historical interaction media resource.

As a possible implementation, the terminal device acquires the first type historical interaction media resource posted by the second user account and the second type historical interaction media resource posted by the first user account. Further, the terminal device prioritizes to display the first type historical interaction media resource on the second interaction page according to the preset time range.

For example, if the preset time range is one month, the terminal device obtains the first type historical interaction media resources and the second type historical interaction media resources within each month. Further, the terminal device prioritizes to display the first type historical interaction media resource, and after displaying the first type historical interaction media resource, the terminal device displays the second type historical interaction media resource.

It is understood that the terminal device classifies the historical interaction media resources into the first type historical interaction media resource and the second type historical interaction media resource, prioritizes to display the first type historical interaction media resource posted by the second user account. In this way, the first user account and the second user account who are in the target social relation can view the media resources post by the other firstly, which can improve the intimacy and enhance the fun of interaction function.

In a design, in order to enhance the intimacy, the first type historical interaction media resource is a media resource associated to the first user account by the second user account based on a first target interaction operation, and the second type historical interaction media resource is a media resource associated to the second user account by the first user account based on a second target interaction operation. As illustrated in FIG. 4, the method for displaying a media resource provided in the embodiments of the disclosure further includes: S203 to S204.

At step S203, the terminal device displays identification information of the associated first user account at a corresponding location of the first type historical interaction media resource on the second interaction page.

As a possible implementation, the terminal device displays the identification information of the associated first user account before the first type historical interaction media resource on the second interaction page.

For example, the target interaction operation is an (@ operation, and the identification information of the first user account is “me”. When obtaining the interaction media resource in which the second user account (@ the first user account, the terminal device displays the interaction media resource on the second interaction page, and displays “mentioned me” before the interaction media resource on the second interaction page.

At step S204, the terminal device displays identification information of the associated second user account at a corresponding location of the second type historical interaction media resource on the second interaction page.

As a possible implementation, the terminal device displays the identification information of the associated second user account before the second type historical interaction media resource on the second interaction page.

For example, if the target interaction operation is an (@ operation, and the identification information of the second user account is “Chen daxian”. When obtaining the interaction media resource in which the first user account (@ the second user account, the terminal device displays the interaction media resource on the second interaction page, and display “mentioned Chen daxian” before the interaction media resource on the second interaction page.

It is understood that in a case that the terminal device detects that the user accounts are associated with each other based on the target interaction operation, the terminal device acquires the interaction media resource. In addition, the terminal device displays the identification information of the user account before displaying the historical interaction media resources. In this way, the identification information of the user account that posts the historical interaction media resource can be seen on the second interaction page, which enhances the display effect and improves the intimacy.

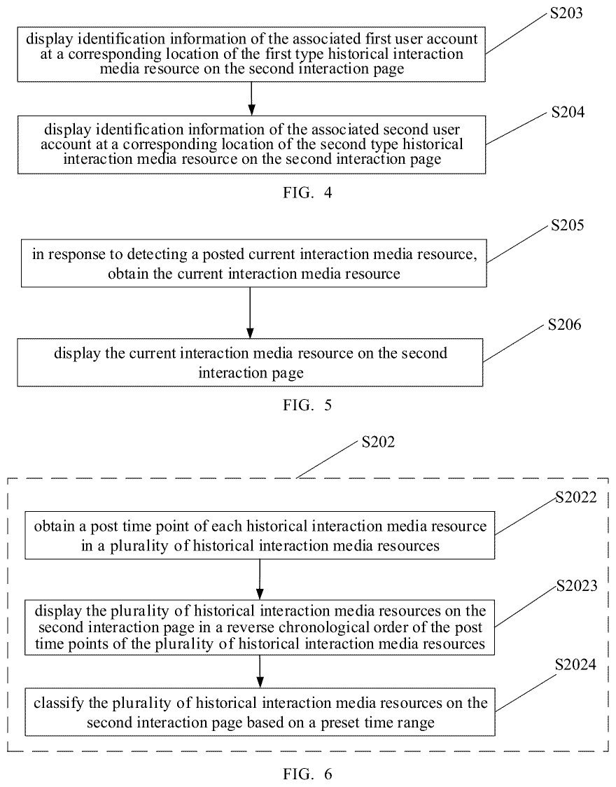

In a design, in order to improve the fun of interaction function, as shown in FIG. 5, the method for displaying a media resource provided in the embodiments of the disclosure further includes: S205 to S206.

At step S205, in response to detecting a posted current interaction media resource, the terminal device obtains the current interaction media resource.

As a possible implementation, the terminal device detects whether the first user account is associated to the second user account through the target interaction operation when a third interaction page is displayed. Further, if the first user account is associated to the second user account through the target interaction operation, the terminal device detects whether the first user account posts an interaction media resource, and after determining that the first user account posts an interaction media resource, the terminal device obtains the current interaction media resource.

For example, the target interaction operation is a forwarding operation, and the interaction media resource is a video. The terminal device detects that the first user account forwards an interaction video to the second user account when the third interaction page is displayed. Further, the terminal device acquires the interaction video.

For example, the target interaction operation is an @ operation, and the interaction media resource is a picture. The terminal device detects that the first user account posts 3 interaction pictures on the third interaction page and @ the second user account when the third interaction page is displayed, the terminal device acquires the 3 interaction pictures.

As a possible implementation, in a case that the terminal device detects, through a target application, that the second user account is associated with the first user account through the target interaction operation, the terminal device detects whether the first user account posts an interaction media resource. If the terminal device detects that the first user account posts an interaction media resource, the terminal device obtains the current interaction media resource.

In detail, in a case that the target application in the terminal device receives a message that the second user account is associated with the first user account through the target interaction operation, the terminal device detects whether the first user account posts an interaction media resource, if the terminal device detects that the first user account posts an interaction media resource, the terminal device obtains the current interaction media resource.

For example, the target interaction operation is an (@ operation, and the interaction media resource is a picture, if the target application in the terminal device receives a message that the second user account (@ the first user account, the terminal device detects whether the second user account posts an interaction media resource, if the terminal device detects that the second user account posts an interaction picture, the terminal device obtains the interaction picture.

It should be noted that the third interaction page may be the same page as the first interaction page or the second interaction page, or it may be a page different from the first interaction page and the second interaction page, which is not limited in the embodiments of the disclosure.

At step S206, the terminal device displays the current interaction media resource on the second interaction page.

As a possible implementation, after obtaining the current interaction media resource, the terminal device generates a collection of target media resources based on the current interaction media resource, and displays the current interaction media resource in order on the second interaction page.

For example, after obtaining the current interaction media resource, the terminal device generates a “memory album” or an “interaction album” based on the current interaction media resource, and displays the interaction media resources in order in the “memory album” or the “interaction album” on the second interaction page.

In some embodiments, the interaction media resources on the second interaction page are ranked in an order of time from recent to previous. After obtaining the current interaction media resource, the terminal device displays the current interaction media resource before the historical interaction media resources on the second interaction page.

For example, the current interaction media resource is a picture. After acquiring the picture, the terminal device displays the picture before the historical interaction media resources on the second interaction page.

In some embodiments, the interaction media resources on the second interaction page are ranked in an order of time from previous to recent. After obtaining the current interaction media resource, the terminal device displays the current interaction media resource after the historical interaction media resources on the second interaction page.

For example, the current interaction media resource is a video. After obtaining the video, the terminal device displays the video after the historical interaction media resources on the second interaction page.

In some embodiments, the terminal device determines that a current interaction media resource posted by the first user account belongs to the second type interaction media resource, and displays the current interaction media resource of the second type at a location corresponding to the second type interaction media resource. Moreover, the terminal device determines that a current interaction media resource posted by the second user account belongs to the first type interaction media resource, and displays the current interaction media resource of the first type at a location corresponding to the first type interaction media resource.

It is understood that upon detecting that the first user account and/or the second user account posts the current interaction media resource, the terminal device obtains the current interaction media resource, and displays it on the second interaction page, which makes it obvious for the user to view and improves the fun of interaction function.

In a design, in order to improve the fun of interaction function, as shown in FIG. 6, step 202 provided in the embodiment of the disclosure further includes: S2022 to S2024.

At step S2022, the terminal device obtains a post time point of each historical interaction media resource in a plurality of historical interaction media resources.

As a possible implementation, the terminal device obtains the post time point of each historical interaction media resource in the plurality of historical interaction media resources before displaying the historical interaction media resources.

For example, the terminal device obtains 5 historical interaction media resources, the terminal device obtains the post time point of each historical interaction media resource of the 5 historical interaction media resources.

At step S2023, the terminal device displays the plurality of historical interaction media resources on the second interaction page in a reverse chronological order of the post time points of the plurality of historical interaction media resources.

For example, the plurality of historical interactions media resources are 5 pictures, the time point of posting the first picture is 2021 Dec. 1, the time point of posting the second picture is 2021 Dec. 3, the time point of posting the third picture is 2021 Dec. 6, the time point of posting the fourth picture is 2021 Nov. 1, and the time point of posting the fifth picture is 2021 Oct. 1. The terminal device displays the 5 pictures in the order of: the third picture, the second picture, the first picture, the fourth picture and the fifth picture.

At step S2024, the terminal device classifies the plurality of historical interaction media resources on the second interaction page based on a preset time range.

In some embodiments, the terminal device classifies the historical interaction media resources by year on the second interaction page.

For example, the historical interaction media resources include historical interaction media resources in 2021 and historical interaction media resources in 2022. The terminal device classifies the historical interaction media resources into the historical interaction media resources in 2021, and the historical interaction media resources in 2022, and displays the historical interaction media resources in 2021 after displaying the historical interaction media resources in 2022.

In some embodiments, the terminal device classifies the historical interaction media resources by month on the second interaction page.

For example, the historical interaction media resources include historical interaction media resources in January 2021, historical interaction media resources in February 2021, and historical interaction media resources in December 2022, the terminal device classifies the historical interaction media resources into the historical interaction media resources in January 2021, the historical interaction media resources in February 2021, and the historical interaction media resources in December 2022, and it display the historical interaction media resources in December 2022, the historical interaction media resources in February 2021, and the historical interaction media resources in January 2021 sequentially.

For example, the historical interaction media resources include historical interaction media resources in January 2021, historical interaction media resources in February 2021, and historical interaction media resources in December 2022, and the historical interaction media resources in January 2021 includes the first type historical interaction media resources and the second type historical interaction media resources. The terminal device classifies the historical interaction media resources into the first type historical interaction media resources in January 2021, the second type historical interaction media resources in January 2021, the historical interaction media resources in February 2021, and the historical interaction media resources in December 2022, and it displays the historical interaction media resources in December 2022, the historical interaction media resources in February 2021, the first type historical interaction media resources in January 2021, and the second type historical interaction media resources in January 2021.

It is understood that the terminal device displays the historical interaction media resources on the second interaction page in the reverse chronological order of the post time points, and classifies the historical interaction media resources according to the preset time range. In this way, all the historical interaction media resources in the preset time range can be displayed in a unified manner, which improves the user interaction experience.

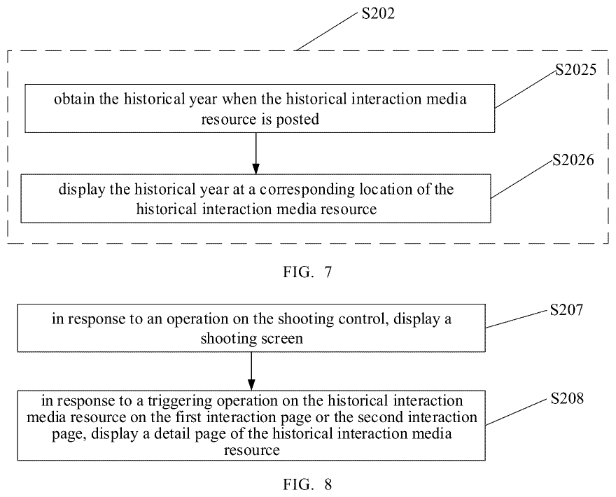

In a design, in order to facilitate the users to view the historical interaction media resources and improve the user experience, in the case where the historical interaction media resources include a historical interaction media resource of a historical year, as shown in FIG. 7, step 202 provided in the embodiment of the disclosure further includes: S2025 to S2026.

At step S2025, the terminal device obtains the historical year when the historical interaction media resource is posted.

As a possible implementation, the terminal device obtains a post year of each historical interaction media resource, and obtains the historical year when the historical interaction media resource is posted based on the current year and the post year.

At step S2026, the terminal device displays the historical year at a corresponding location of the historical interaction media resource.

For example, the historical interaction media resource includes historical interaction media resources in 2018, historical interaction media resources in 2019, and historical interaction media resources in 2020. The terminal device displays “2018” before the historical interaction media resources in 2018, “2019” before the historical interaction media resources in 2019, and “2020” before the historical interaction media resources in 2020.

It is understood that the terminal device displays the historical year corresponding to the historical interaction media resources on the second interaction page, which facilitates the users to view the historical interaction media resources and improves the user experience.

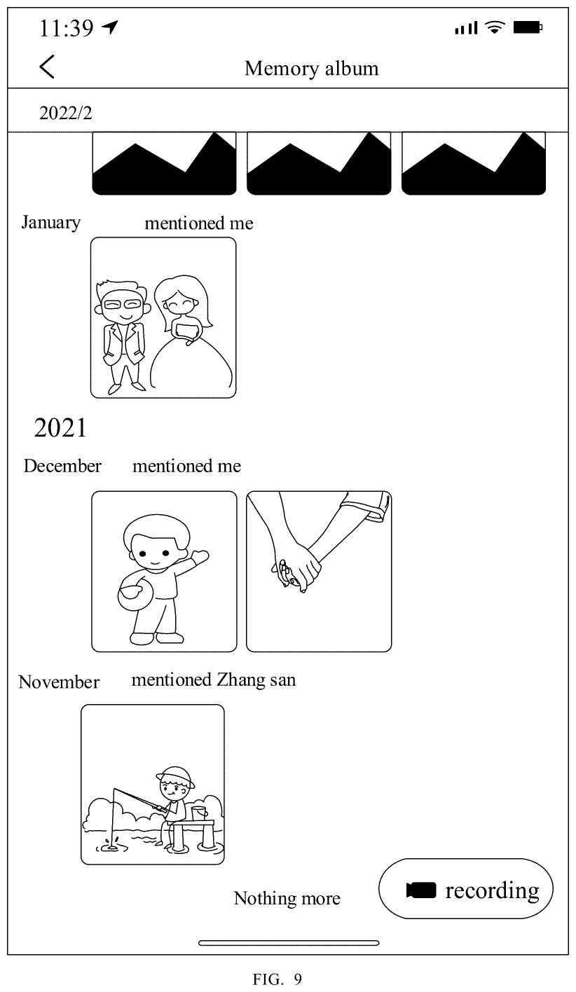

In a design, in order to facilitate posting the interaction media resources, the first interaction page and the second interaction page also include a shooting control, as shown in FIG. 8, the method for displaying a media resource provided in the embodiment of the disclosure further includes steps S207 to S208.

At step S207, in response to an operation on the shooting control, the terminal device displays a shooting screen.

For example, the shooting control is a “shooting” control, in response to a click operation on the “shooting” control, the terminal device calls a camera to capture a picture and displays the picture.

In another case, the terminal device displays a captured picture in response to an operation on a shooting area.

For example, the shooting area is a “shooting” area, in response to a long press operation on the “shooting” area, the terminal device calls the camera to capture a picture and displays the picture.

Subsequently, the terminal device obtains the captured picture in response to the shooting operation and displays the captured picture on a fourth interaction page.

It is noted that the fourth interaction page may be the same page as the third interaction page, or may be a page different from the third interaction page.

At step S208, in response to a triggering operation on the historical interaction media resource on the first interaction page or the second interaction page, the terminal device displays a detail page of the historical interaction media resource.

As a possible implementation, upon detecting the triggering operation on the historical interaction media resource on the first interaction page or the second interaction page, the terminal device displays the detail page of the historical interaction media resource in response to the triggering operation on the historical interaction media resource on the first interaction page or the second interaction page.

For example, the historical interaction media resource is a video on the first interaction page, the terminal device enters a video playback page in response to a click operation on the video on the first interaction page.

It is noted that S207 and S208 in the embodiments of the disclosure are two independent steps and are not executed in a certain order.

It is understood that the shooting control is displayed on the first interaction page and the second interaction page, the terminal device can quickly enter the shooting scene in response to the operation on the shooting control, which facilitates posting the interaction media resource. In addition, in response to the triggering operation on the historical interaction media resource, the terminal device displays the detail page of the historical interaction media resource. In this way, it is convenient for the users to view the details of the historical interaction media resource, which facilitates the users to recall memories, improves the user experience and enhances the user viscosity.

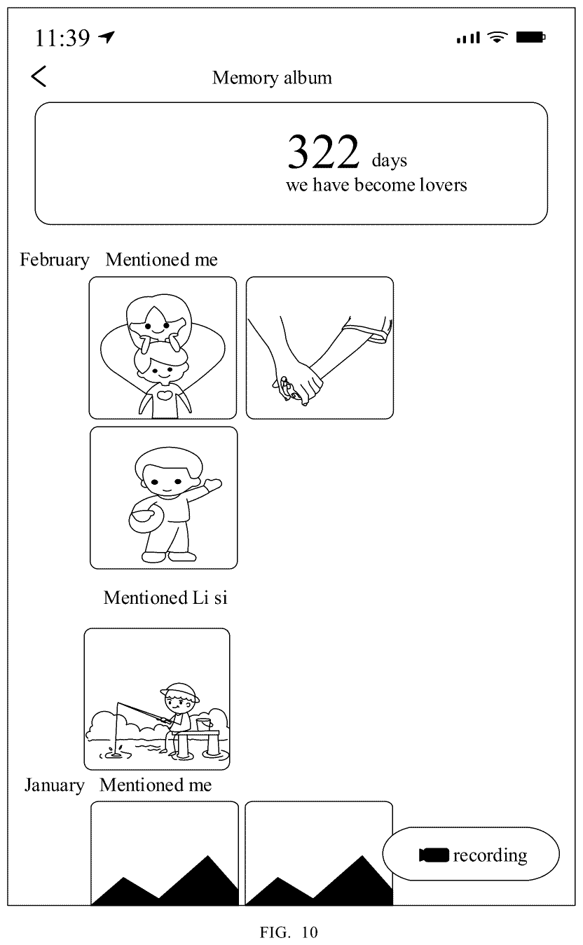

In addition, to explain the second interaction page, the display contents of the second interaction page are illustrated with reference to FIGS. 9 and 10. In detail, the second interaction page in FIG. 9 displays a “memory album” and displays a part of the historical interaction media resources in February 2022 and a picture that mentioned the first user account by the second user account in January 2022. In addition, FIG. 9 also illustrate pictures that mentioned the first user account by the second user account in December 2021 and a picture that mentioned the second user account by the first user account in November 2021. The nickname of the second user account, i.e., “Zhang san”, and the “recording” shooting control are also shown on the second interaction page.

In FIG. 10, the second interaction page displays a “memory album” and “322 days we have become lovers”. In addition, the second interaction page also illustrates pictures that mentioned the first user account by the second user account in the current month of February, a picture that mentioned the second user account by the first user account in the current month of February, and pictures that mentioned the first user account by the second user account in the current month of January. The nickname of the second user account, i.e., “Li si”, and the “recording” shooting control are also shown on the second interaction page.

The disclosure provides the method for displaying a media resource, which brings about the following beneficial effects. The terminal device displays the first interaction page corresponding to the first user account in the case that the first user account has established the target social relation (e.g., an intimate relation or a friend relation) with the second user account, in which the first interaction page is configured to display the interaction information between the first user account and the second user account. Further, the terminal device displays the second interaction page in response to the triggering operation on the interaction media resource entry, in which the second interaction page is configured to display the historical interaction media resource, and the historical interaction media resource includes one or more media resources generated based on one or more historical interaction operation between the first user account and the second user account.

In this way, after establishing the target social relation between the first user account and the second user account, the terminal device can display the historical interaction media resource between the first user account and the second user account, which makes it convenient for the users who are in the target social relation to view the interaction media resources, and enhances the fun of interaction function. In addition, by displaying the historical interaction media resource, the motivation for interaction between the users who are in the target social relation is enhanced and the user viscosity is improved.

The above contents introduce the solution provided by the embodiments of the disclosure from the perspective of methods. In order to realize the functions described above, an apparatus or a terminal for displaying a media resource includes hardware structures and/or software modules that perform respective functions. It should be readily apparent to those skilled in the art that, in combination with the units and algorithmic steps of the various examples described in the embodiments disclosed herein, the disclosure can be implemented in the form of hardware or a combination of hardware and computer software. Whether a particular function is implemented as hardware or computer software driving hardware depends on the particular application and design constraints of the technical solution. Those skilled in the art may use different methods for each particular application to achieve the described functions, but such implementations should not be considered as outside the scope of this disclosure.

The embodiments of the disclosure may exemplarily classify the apparatus or the terminal for displaying a media resource into function modules according to the above method. For example, the apparatus or the terminal for displaying a media resource may include various function modules corresponding to respective functions, or two or more functions may be integrated in one processing module. The above integrated module may be realized either in the form of hardware or in the form of software function module. It should be noted that the classification of the modules in the embodiments of the disclosure is schematic and is only a logical function division, and other division modes may also be implemented in practice.

For example, the embodiments of the disclosure also provide an apparatus for displaying a media resource.

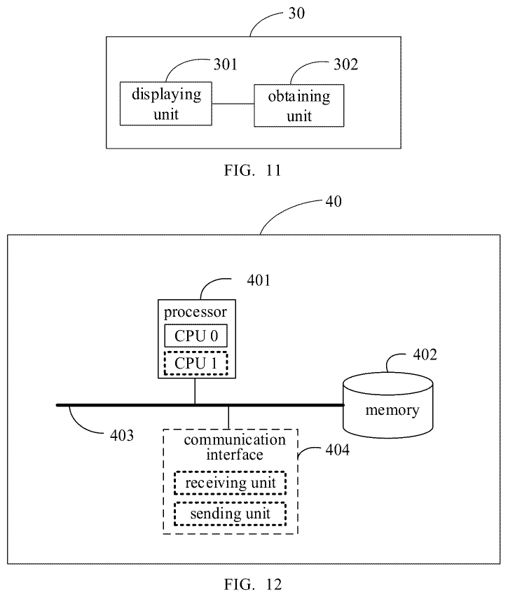

The embodiments of the disclosure provide an apparatus 30 for displaying a media resource, applied to a terminal device of a first user account. As illustrated in FIG. 11, the apparatus 30 for displaying a media resource includes: a displaying unit 301.

The displaying unit 301 is configured to display a first interaction page corresponding to the first user account, in which the first interaction page is configured to display interaction information between the first user account and a second user account, the first user account and the second user account are in a target social relation, and the interaction information includes a historical interaction media resource.

The first interaction page includes an interaction media resource entry. The displaying unit 301 is further configured to display a second interaction page in response to a triggering operation on the interaction media resource entry, in which the second interaction page is configured to display the historical interaction media resource, and the historical interaction media resource includes one or more media resources generated based on one or more historical interaction operations between the first user account and the second user account.

In a possible implementation, the displaying unit 301 is further configured to: display a first type historical interaction media resource and a second type historical interaction media resource on the second interaction page, in which the first type historical interaction media resource is posted by the second user account, the second type historical interaction media resource is posted by the first user account, and a display priority of the first type historical interaction media resource is higher than a display priority of the second type historical interaction media resource.

In a possible implementation, the first type historical interaction media resource is a media resource associated to the first user account by the second user account based on a first target interaction operation, and the second type historical interaction media resource is a media resource associated to the second user account by the first user account based on a second target interaction operation. The displaying unit 301 is further configured to: display identification information of the associated first user account at a corresponding location of the first type historical interaction media resource on the second interaction page; and display identification information of the associated second user account at a corresponding location of the second type historical interaction media resource on the second interaction page.

In a possible implementation, the apparatus 30 for displaying a media resource further includes an obtaining unit 302. The obtaining unit 302 is configured to: in response to detecting a current interaction media resource posted, obtain the current interaction media resource. The obtaining unit 302 is further configured to: display the current interaction media resource on the second interaction page.

In a possible implementation, the displaying unit 301 is further configured to: obtain a post time point of each historical interaction media resource in a plurality of historical interaction media resources, and display the plurality of historical interaction media resources on the second interaction page in a reverse chronological order of the post time points of the plurality of historical interaction media resources, and classify the plurality of historical interaction media resources on the second interaction page based on a preset time range.

In a possible implementation, in response to the historical interaction media resource including a historical interaction media resource of a historical year, the displaying unit 301 is further configured to: obtain the historical year when the historical interaction media resource is posted, and display the historical year at a corresponding location of the historical interaction media resource.

In a possible implementation, the first interaction page and the second interaction page include a shooting control, and the displaying unit 301 is further configured to: display a shooting screen in response to an operation on the shooting control; and display a detail page of the historical interaction media resource in response to a triggering operation on the historical interaction media resource on the first interaction page or the second interaction page.

If the functions of the above integrated modules are realized in the form of hardware, the embodiments of the disclosure provide a schematic diagram of a possible structure of the terminal device involved in the above embodiments. As shown in FIG. 12, the terminal device 40 includes a processor 401, a memory 402, and a bus 403. The processor 401 and the memory 402 may be connected to each other via the bus 403.

The processor 401 may be a control center of a communication device, a processor, or a collective of a plurality of processing elements. For example, the processor 401 may be a general central processing unit (CPU) or other general processors. The general processor may be a microprocessor or any conventional processor.

As an embodiment, the processor 401 may include one or more CPUs, such as CPU 0 and CPU 1 shown in FIG. 12.

The memory 402 may be a read-only memory (ROM) or other types of static storage devices that store static information and instructions, a random access memory (RAM) or other types of dynamic storage devices that store information and instructions, an electrically erasable programmable read-only memory (EEPROM), a magnetic storage media or other magnetic storage devices, or any other medium capable of being used to carry or store desired program codes in the form of instructions or data structures and capable of being accessed by a computer, which is not limited herein.

As a possible implementation, the memory 402 can exist independently of the processor 401, and the memory 402 can be connected to the processor 401 via the bus 403 for storing instructions or program codes. When the processor 401 calls and executes the instructions or program codes stored in the memory 402, the method for displaying a media resource of the embodiments of the disclosure is implemented.

In another possible implementation, the memory 402 can also be integrated with the processor 401.

The bus 403 can be an industry standard architecture (ISA) bus, a peripheral component interconnect (PCI) bus or an extended industry standard architecture (EISA) bus. The bus can be categorized as an address bus, a data bus, or a control bus. For ease of representation, the bus is represented by only one thick line in FIG. 12, but it does not indicate that there is only one bus or one type of bus.

It is noted that the structure illustrated in FIG. 12 does not constitute a limitation of the terminal device 40. In addition to the components shown in FIG. 12, the terminal device 40 may include more or fewer components than illustrated, or a combination of certain components, or different arrangements of components.

Optionally, the terminal device 40 provided by the embodiments of the disclosure may also include a communication interface 404.

The communication interface 404 is used to connect with other devices via a communication network. The communication network may be an Ethernet network, a wireless access network, a wireless local area network (WLAN), and the like. The communication interface 404 may include a receiving unit for receiving data, and a sending unit for sending data.

In a design, the communication interface may also be integrated in the processor of the terminal device 40 provided in the embodiments of the disclosure.

In another hardware structure of a server provided by the embodiment of the disclosure, the terminal device may include a processor and a communication interface that are coupled to the processor.

The functions of the processor may be described with reference to the descriptions of the processor described above. In addition, the processor has a storage function, which may be described with reference to the function of the memory described above.

The communication interface is used to provide data to the processor. The communication interface may be an internal interface of a communication device or an interface external to the communication device.

It is noted that the above-described another hardware structure does not constitute a limitation of the server. In addition to such hardware structure, the server may include more or fewer components, or a combination of certain components, or different arrangements of components.

If the functions of the above integrated module are realized in the form of hardware, the embodiments of the disclosure provide the structural schematic diagram of a middleware involved in the above embodiments, which can be referred to the structural schematic diagrams described above.

The embodiments of the disclosure also provide a computer-readable storage medium having instructions stored therein. When the instructions are executed by a computer, the computer executes the steps in the method for displaying a media resource shown in the above method embodiments.

The embodiments of the disclosure also provide a computer program product including instructions. When the instructions are run by a computer, the computer is caused to execute the method for displaying a media resource in the above method embodiments.

The computer-readable storage medium, for example, may be, but is not limited to, an electrical, magnetic, optical, electromagnetic, infrared, or semiconducting system, apparatus or device, or any combination of the above. Specific examples of the computer-readable storage medium (non-exhaustive) include: an electrical link having one or more wires, a portable computer disk, a hard disk, a RAM, a ROM, an EPROM, a register, a hard disk, an optical fiber, a portable compact disk read-only memory (CD-ROM), an optical storage device, a magnetic storage device, any appropriate combination of the above, or any other form of computer-readable storage medium that are well known by those skilled in the art. An exemplary storage medium is coupled to the processor, such that the processor is capable of reading information from the storage medium and writing information to the storage medium. Certainly, the storage medium may also be a component of the processor. The processor and the storage medium may be located in an application specific integrated circuit (ASIC). In the embodiment of the disclosure, the computer-readable storage medium may be any tangible medium that contains or stores programs that may be used by or in combination with an instruction execution system, device, or apparatus.

Since the server, the user equipment, the computer-readable storage medium, and the computer program product in the embodiments of the disclosure can be applied to the above-described method, the technical effects that can be obtained therefrom can also be referred to the above-described method embodiments, which will not be repeated in the embodiments of the disclosure.

The above are only specific embodiments of the disclosure, but the scope of protection of the disclosure is not limited thereto, and any changes or substitutions within the technical scope disclosed in the disclosure shall be covered by the scope of protection of the disclosure.

What is claimed is:

1. A method for displaying a media resource, performed by a terminal device of a first user account, comprising:
displaying a first interaction page corresponding to the first user account, wherein the first interaction page is configured to display interaction information between the first user account and a second user account, the first user account and the second user account are in a target social relation, the interaction information comprises a historical interaction media resource, and the historical interaction media resource comprises one or more media resources generated based on one or more historical interaction operations between the first user account and the second user account; and
displaying a second interaction page in response to a triggering operation on an interaction media resource entry, wherein the first interaction page comprises the interaction media resource entry, and the second interaction page is configured to display the historical interaction media resource.

2. The method of claim 1, wherein displaying the second interaction page configured to display the historical interaction media resource comprises:
displaying a first type historical interaction media resource and a second type historical interaction media resource on the second interaction page, wherein the first type historical interaction media resource is posted by the second user account, the second type historical interaction media resource is posted by the first user account, and a display priority of the first type historical interaction media resource is higher than a display priority of the second type historical interaction media resource.

3. The method of claim 2, wherein the first type historical interaction media resource is a media resource associated to the first user account by the second user account based on a first target interaction operation, and the second type historical interaction media resource is a media resource associated to the second user account by the first user account based on a second target interaction operation, and the method further comprises:
displaying identification information of the associated first user account at a corresponding location of the first type historical interaction media resource on the second interaction page; and
displaying identification information of the associated second user account at a corresponding location of the second type historical interaction media resource on the second interaction page.

4. The method of claim 1, further comprising:
in response to detecting a current interaction media resource posted, obtaining the current interaction media resource and displaying the current interaction media resource on the second interaction page.

5. The method of claim 1, wherein displaying the second interaction page configured to display the historical interaction media resource comprises:
obtaining a post time point of each historical interaction media resource in a plurality of historical interaction media resources, and displaying the plurality of historical interaction media resources on the second interaction page in a reverse chronological order of the post time points of the plurality of historical interaction media resources; and
classifying the plurality of historical interaction media resources on the second interaction page based on a preset time range.

6. The method of claim 1, wherein in response to the historical interaction media resource comprising a historical interaction media resource for a historical year, displaying the second interaction page configured to display the historical interaction media resource comprises:
obtaining the historical year when the historical interaction media resource is posted, and displaying the historical year at a corresponding location of the historical interaction media resource.

7. The method of claim 1, wherein the first interaction page and the second interaction page comprise a shooting control, and the method further comprises:
displaying a shooting screen in response to an operation on the shooting control; and
displaying a detail page of the historical interaction media resource in response to a triggering operation on the historical interaction media resource on the first interaction page or the second interaction page.

8. A terminal device comprising: a processor and a communication interface coupled to the processor, wherein the processor is configured to execute computer programs or instructions to implement a method for displaying a media resource, the method comprising:
displaying a first interaction page corresponding to the first user account, wherein the first interaction page is configured to display interaction information between the first user account and a second user account, the first user account and the second user account are in a target social relation, the interaction information comprises a historical interaction media resource, and the historical interaction media resource comprises one or more media resources generated based on one or more historical interaction operations between the first user account and the second user account; and
displaying a second interaction page in response to a triggering operation on an interaction media resource entry, wherein the first interaction page comprises the interaction media resource entry, and the second interaction page is configured to display the historical interaction media resource.

9. The terminal device of claim 8, wherein displaying the second interaction page configured to display the historical interaction media resource comprises:
displaying a first type historical interaction media resource and a second type historical interaction media resource on the second interaction page, wherein the first type historical interaction media resource is posted by the second user account, the second type historical interaction media resource is posted by the first user account, and a display priority of the first type historical interaction media resource is higher than a display priority of the second type historical interaction media resource.

10. The terminal device of claim 9, wherein the first type historical interaction media resource is a media resource associated to the first user account by the second user account based on a first target interaction operation, and the second type historical interaction media resource is a media resource associated to the second user account by the first user account based on a second target interaction operation, and the method for displaying a media resource further comprises:
displaying identification information of the associated first user account at a corresponding location of the first type historical interaction media resource on the second interaction page; and
displaying identification information of the associated second user account at a corresponding location of the second type historical interaction media resource on the second interaction page.

11. The terminal device of claim 8, wherein the method for displaying a media resource further comprises:
in response to detecting a current interaction media resource posted, obtaining the current interaction media resource and displaying the current interaction media resource on the second interaction page.

12. The terminal device of claim 8, wherein displaying the second interaction page configured to display the historical interaction media resource comprises:
obtaining a post time point of each historical interaction media resource in a plurality of historical interaction media resources, and displaying the plurality of historical interaction media resources on the second interaction page in a reverse chronological order of the post time points of the plurality of historical interaction media resources; and
classifying the plurality of historical interaction media resources on the second interaction page based on a preset time range.

13. The terminal device of claim 8, wherein in response to the historical interaction media resource comprising a historical interaction media resource for a historical year, displaying the second interaction page configured to display the historical interaction media resource comprises:
obtaining the historical year when the historical interaction media resource is posted, and displaying the historical year at a corresponding location of the historical interaction media resource.

14. The terminal device of claim 8, wherein the first interaction page and the second interaction page comprise a shooting control, and the method for displaying a media resource further comprises:
displaying a shooting screen in response to an operation on the shooting control; and
displaying a detail page of the historical interaction media resource in response to a triggering operation on the historical interaction media resource on the first interaction page or the second interaction page.

15. A non-transitory computer-readable storage medium having instructions stored thereon, wherein when the instructions are executed by a computer, a method for displaying a media resource is implemented by the computer, the method comprising:
displaying a first interaction page corresponding to the first user account, wherein the first interaction page is configured to display interaction information between the first user account and a second user account, the first user account and the second user account are in a target social relation, the interaction information comprises a historical interaction media resource, and the historical interaction media resource comprises one or more media resources generated based on one or more historical interaction operations between the first user account and the second user account; and
displaying a second interaction page in response to a triggering operation on an interaction media resource entry, wherein the first interaction page comprises the interaction media resource entry, and the second interaction page is configured to display the historical interaction media resource.

16. The non-transitory computer-readable storage medium of claim 15, wherein displaying the second interaction page configured to display the historical interaction media resource comprises:
displaying a first type historical interaction media resource and a second type historical interaction media resource on the second interaction page, wherein the first type historical interaction media resource is posted by the second user account, the second type historical interaction media resource is posted by the first user account, and a display priority of the first type historical interaction media resource is higher than a display priority of the second type historical interaction media resource.

17. The non-transitory computer-readable storage medium of claim 16, wherein the first type historical interaction media resource is a media resource associated to the first user account by the second user account based on a first target interaction operation, and the second type historical interaction media resource is a media resource associated to the second user account by the first user account based on a second target interaction operation, and the method for displaying a media resource further comprises:
displaying identification information of the associated first user account at a corresponding location of the first type historical interaction media resource on the second interaction page; and
displaying identification information of the associated second user account at a corresponding location of the second type historical interaction media resource on the second interaction page.

18. The non-transitory computer-readable storage medium of claim 15, wherein the method for displaying a media resource further comprises:
in response to detecting a current interaction media resource posted, obtaining the current interaction media resource and displaying the current interaction media resource on the second interaction page.

19. The non-transitory computer-readable storage medium of claim 15, wherein displaying the second interaction page configured to display the historical interaction media resource comprises:
obtaining a post time point of each historical interaction media resource in a plurality of historical interaction media resources, and displaying the plurality of historical interaction media resources on the second interaction page in a reverse chronological order of the post time points of the plurality of historical interaction media resources; and
classifying the plurality of historical interaction media resources on the second interaction page based on a preset time range.

20. The non-transitory computer-readable storage medium of claim 15, wherein in response to the historical interaction media resource comprising a historical interaction media resource for a historical year, displaying the second interaction page configured to display the historical interaction media resource comprises:
obtaining the historical year when the historical interaction media resource is posted, and displaying the historical year at a corresponding location of the historical interaction media resource.
